(19) United States
(12) Patent Application Publication
(10) Pub. No.: US 2005/0006972 A1
(43) Pub. Date: Jan. 13, 2005

(54) Twin coil claw pole rotor with segmented stator winding for electrical machine

(76) Inventor: Michael D. Bradfield, Anderson, IN (US)

Correspondence Address: James J. Merrick;Cantor Colburn LLP, 55 Griffin Road South, Bloomfield, CT, 06002, US

(21) Appl. No.: 10/713,802

(22) Filed: Nov. 14, 2003

Related U.S. Application Data
(60) Provisional application No. 60/485,610, filed on Jul. 7, 2003.

(51) Int. Cl. H02K 1/00; H02K 3/00; H02K 21/00

(52) U.S. Cl. 310/180

(57) ABSTRACT

A dynamoelectric machine including a stator with a stator winding composed of segmented conductors and representative of a first phase stator winding of multi-phase stator windings inserted in a plurality of slots defining the stator. A rotor is rotatable within the stator and is composed of more than two flux carrying segments, each segment having P/2 claw poles, wherein P is an even number.

CROSS REFERENCE TO RELATED APPLICATION

This application claims the benefit of U.S. Provisional Application No. 60/485,610, filed Jul. 7, 2003 the contents of which are incorporated by reference herein in their entirety.

### TECHNICAL FIELD

This application relates generally to an electrical apparatus. More specifically, this application relates to a twin coil rotor for an electrical machine and enhancing output and efficiency of the same.

### BACKGROUND

Electrical loads for vehicles continue to escalate. At the same time, the overall package size available for the electrical generator continues to shrink. Consequently there is a need for a higher power density system and method of generating on-board electricity.

Two important components of the generator are the rotor and the stator. In most generators, the stator contains the main current-carrying winding in which electromotive force produced by magnetic flux is induced from communication with the rotor winding. The three-phase alternating current is rectified into a direct current, which can be stored in a battery of a vehicle or be used directly by the electrical circuit of the vehicle which is supplied with a direct current (DC) voltage.

Typically, the stator winding consists of conducting wire, which is wound and inserted into a slot of the stator. In both the rotor and stator, the wire is wound and inserted into a slot in bundles. The prior art teaches the winding and insertion of wire having a rounded profile. This rounded wire, however, has several disadvantages associated with its use in a conventional rotor.

First, the bundles of rounded wire do not occupy the rotor slot in an efficient manner. This conventional design produces a lower output current and is less efficient electrically than a design in which the wire occupies a higher ratio of the slot.

Second, the use of rounded wire in the conventional manner results in poor heat conduction because the wire is loosely bundled in the slot. This poor heat conduction results in higher rotor wire temperatures, for example. In turn, this higher temperature decreases the reliability, performance, and efficiency of the wire.

Third, in some cases, square or rectangular shaped wire is used to increase the fill factor and decrease the volume of space occupied by the winding. This approach, however, is not cost effective as non-round wire is generally twice the cost of round wire. Non-round wire also has a processing disadvantage because additional tooling and /or processing is needed to reel and de-reel the wire as well as to wind the non-round conductor on a given coil. These difficulties arise from the fact that the non-round conductor must be precisely oriented during processing to ensure that it lays flat, square, and true.

There is therefore a need for a coil winding for a generator that minimizes or eliminates one or more of the problems set forth above while allowing for a higher power density system in a smaller overall package.

### BRIEF SUMMARY OF THE INVENTION

The above discussed and other drawbacks and deficiencies are overcome or alleviated by a dynamoelectric machine including a stator with a stator winding composed of segmented conductors and representative of a first phase stator winding of multi-phase stator windings inserted in a plurality of slots defining the stator. A rotor is rotatable within the stator and is composed of more than two flux carrying segments, each segment having P/2 claw poles, wherein P is an even number.

In an exemplary embodiment, the first phase stator winding includes a conductor segmented into a first segment and a second segment, the first segment is inserted in a first slot of the plurality of slots and the second segment is inserted in a second slot of the plurality of slots, the first and second slots having two slots therebetween. The first and second segments extend from a first side of the stator to a second side defining the stator. The first segment returns to the first side through the second slot and the second segment returns to the first side through a third slot. The second slot disposed between the first and third slots while the second and third slots have two slots therebetween. In this manner, it is possible to increase the cross sectional area of conductive windings per stator slot and reduce the ohmic loss of the stator, thereby increasing the electrical generating efficiency.

### BRIEF DESCRIPTION OF THE DRAWINGS

FIG. 1 is a sectional view of an AC generator incorporating a stator assembly and a twin coil three segment claw pole rotor assembly constructed in accordance with the present invention;

FIG. 2 is a perspective view of the rotor assembly of FIG. 1;

FIG. 3 is a circuit diagram of an exemplary embodiment of a stator assembly of FIG. 1 having a three-phase stator winding in operable communication with corresponding three-phase bridge rectifier and the twin coil rotor assembly;

FIG. 4 is plan view of the stator assembly having a pair of segmented conductor windings in each stator slot in accordance with an exemplary embodiment;

FIG. 5 is a partial cross sectional view of the stator assembly of FIG. 4 illustrating the two segmented conductors per stator slot;

FIG. 6 is a partial cross sectional view of an alternative embodiment of FIG. 5 illustrating four segmented conductors per stator slot; and

FIG. 7 is plan view of the stator assembly of FIG. 4 illustrating one segmented conductor winding of a single phase wound in three stator slots in accordance with an exemplary embodiment.

### DESCRIPTION OF THE PREFERRED EMBODIMENT

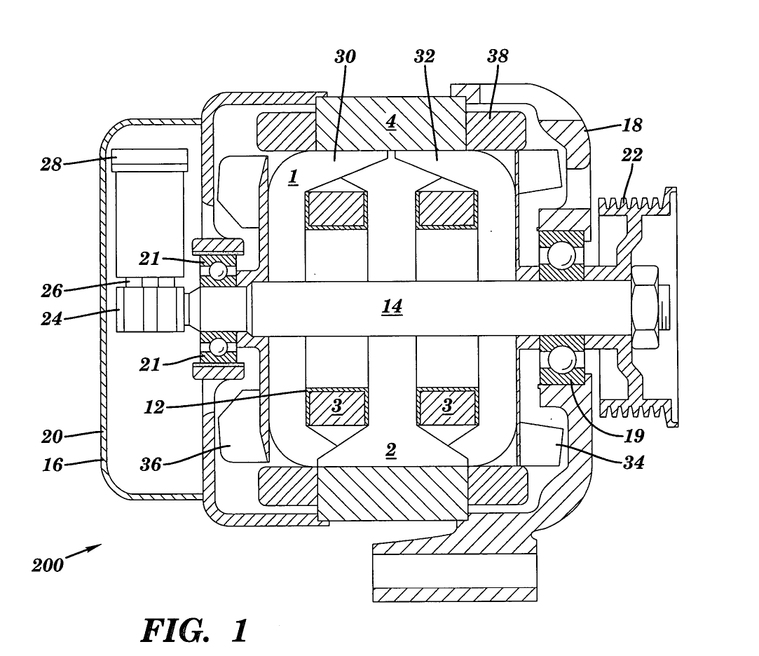

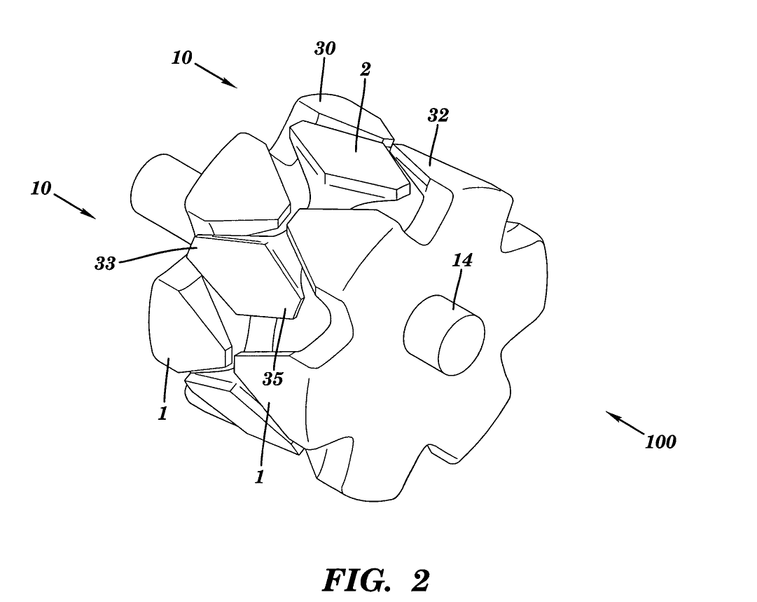

Referring to FIGS. 1 and 2, an exemplary embodiment of a rotor assembly 100 having three claw pole segments is illustrated. The two outbound claw pole segments, or end segments 1, are aligned with each other such that they point towards each other and define a width of the rotor assembly 100. Each end segment 1 has P/2 claw poles where P is an even number and representative of the total number of poles. A third, and center claw pole segment 2 is disposed intermediate end segments 1. Center claw pole segment 2 has poles that project toward the outbound claw pole segments 1 and is typically symmetrical about its center. More specifically, each pole of center claw pole segment 2 extends between a gap 10 created between contiguous claw poles of each end segment 1. Center claw pole segment 2 also has P/2 claw poles where P is an even number corresponding to P for the number of P/2 claw poles of each end segment 1. It will be noted that outbound end claw pole segments 1 are disposed on an outer circumferential edge at a uniform angular pitch in a circumferential direction so as to project axially, and each of the opposing claw pole segments 1 are fixed to shaft 14 facing each other such that the end segment claw-shaped magnetic poles would intersect if they were extended. Furthermore, center claw pole segment 2 is disposed in gap 10 defined by contiguous segments 1 such that a pair of opposing first and second claw-shaped magnetic poles 33 and 35 extending axially defining a circumferential periphery of each center pole segment intermesh with claw-shaped magnetic poles 30 and 32 defining end segments 1.

A field coil winding 3 is located between each end pole segment 1 on a corresponding bobbin 12 for a total of two field coil windings 3. The field coil windings 3 are energized such that the magnetic polarity of the outbound or end pole segments 1 are the same and opposite the center pole segment 2. Such an arrangement for the field rotor produces a stronger rotating magnetic field and allows the axial length of a stator 4 to be more effectively lengthened compared to a claw-pole Lundell alternator. It will be recognized by one skilled in the pertinent art that permanent magnets can be placed between the claw pole segments 1, 2 to further enhance output and efficiency of the stator 4 and rotor assembly 100.

Referring now to FIG. 1, rotor assembly 100 is disposed in a dynamoelectric machine 200 that operates as an alternator in an exemplary embodiment, but not limited thereto, and is constructed by rotatably mounting a Lundell-type rotor or rotor assembly 100 by means of a shaft 14 inside a case 16 constituted by a front bracket 18 and a rear bracket 20 made of aluminum and fixing stator 4 to an inner wall surface of the case 16 so as to cover an outer circumferential side of the rotor assembly 100.

The shaft 14 is rotatably supported in the front bracket 18 via bearing 19 and the rear bracket 20 via bearing 21. A pulley 22 is fixed to a first end of this shaft 14, enabling rotational torque from an engine to be transmitted to the shaft 14 by means of a belt (not shown).

Slip rings 24 for supplying an electric current to the rotor assembly 100 are fixed to a second end portion of the shaft 14, a pair of brushes 26 being housed in a brush holder 28 disposed inside the case 16 so as to slide in contact with these slip rings 24. A voltage regulator (not shown) for adjusting the magnitude of an alternating voltage generated in the stator 4 is operably coupled with the brush holder 28.

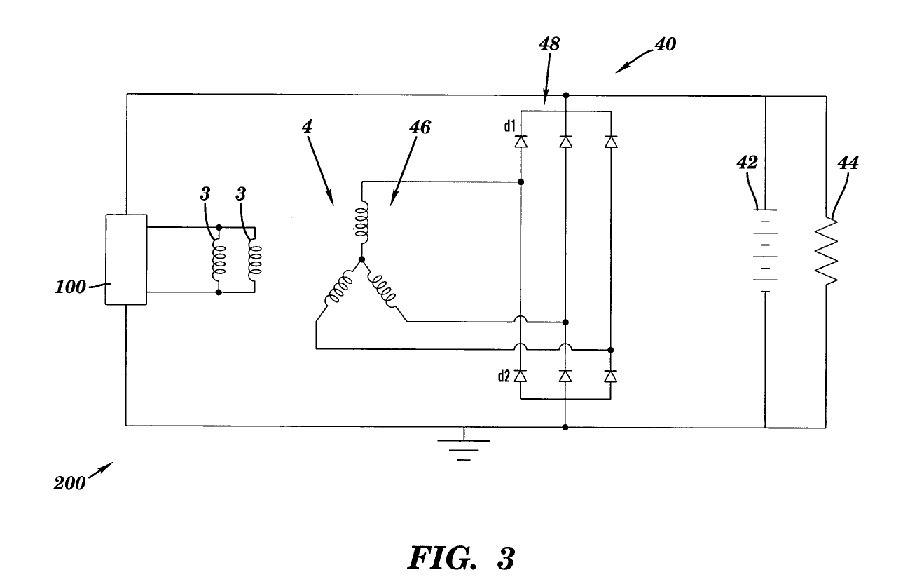

A rectifier 40 (see FIG. 3) for converting alternating current generated in the stator 4 into direct current is mounted inside case 16, the rectifier 40 being constituted by a three-phase full-wave rectifier in which three diode pairs, respectively, are connected in parallel, each diode pair being composed of a positive-side diode d₁, and a negative-side diode d₂ connected in series (see FIG. 3). Output from the rectifier 40 can be supplied to a storage battery 42 and an electric load 44.

As described above, the rotor assembly 100 is constituted by: the pair of field windings 3 for generating a magnetic flux on passage of an electric current; and pole cores or segments 1 and 2 disposed so as to cover the field windings 3, magnetic poles being formed in the segments 1 and 2 by the magnetic flux generated by the field windings 3. The end and center segments 1 and 2, respectively, are preferably made of iron, each end segment 1 having two first and second claw-shaped magnetic poles 30 and 32, respectively, disposed on an outer circumferential edge and aligned with each other in a circumferential direction so as to project axially, and the end segment pole cores 30 and 32 are fixed to the shaft 14 facing each other such that the center segment core is therebetween the claw-shaped end segment magnetic poles 30 and 32 and intermesh with the magnetic poles 33 and 35 of center segment 2, respectively, as best seen in FIG. 2.

Still referring to FIG. 1, fans 34 and 36 (internal fans) are fixed to first and second axial ends of the rotor assembly 100. Front-end and rear-end air intake apertures (not shown) are disposed in axial end surfaces of the front bracket 18 and the rear bracket 20, and front-end and rear-end air discharge apertures (not shown) are disposed in first and second outer circumferential portions of the front bracket 18 and the rear bracket 20 preferably radially outside front-end and rear-end coil end groups of the armature or stator winding 38 installed in the stator core 4.

In the dynamoelectric machine 200 constructed in this manner, an electric current is supplied to the twin field windings 3 from the storage battery through the brushes 26 and the slip rings 24, generating a magnetic flux. The first claw-shaped magnetic poles 30 and 32 of the end segments 1 are magnetized into a fixed polarity by this magnetic flux (such as North seeking (N) poles), and the center claw- shaped magnetic poles 33 and 35 are magnetized into the opposite polarity (such as South-seeking (S) poles). At the same time, rotational torque from the engine is transmitted to the shaft 14 by means of the belt (not shown) and the pulley 22, rotating the rotor assembly 100. Thus, a rotating magnetic field is imparted to the armature winding 38, inducing a voltage across the armature winding 38.

Referring now to FIG. 3, the dynamoelectric machine 200 is illustrated as a circuit diagram. This alternating-current electromotive force passes through rectifier 40 and is converted into direct current, the magnitude thereof is adjusted by the voltage regulator (not shown), a storage battery 42 is charged, and the current is supplied to an electrical load 44.

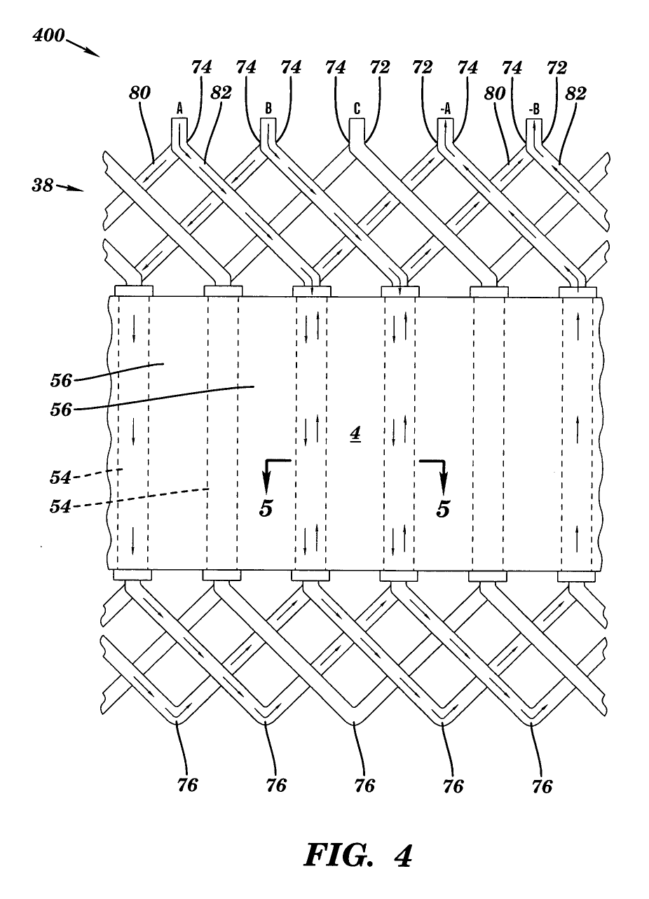

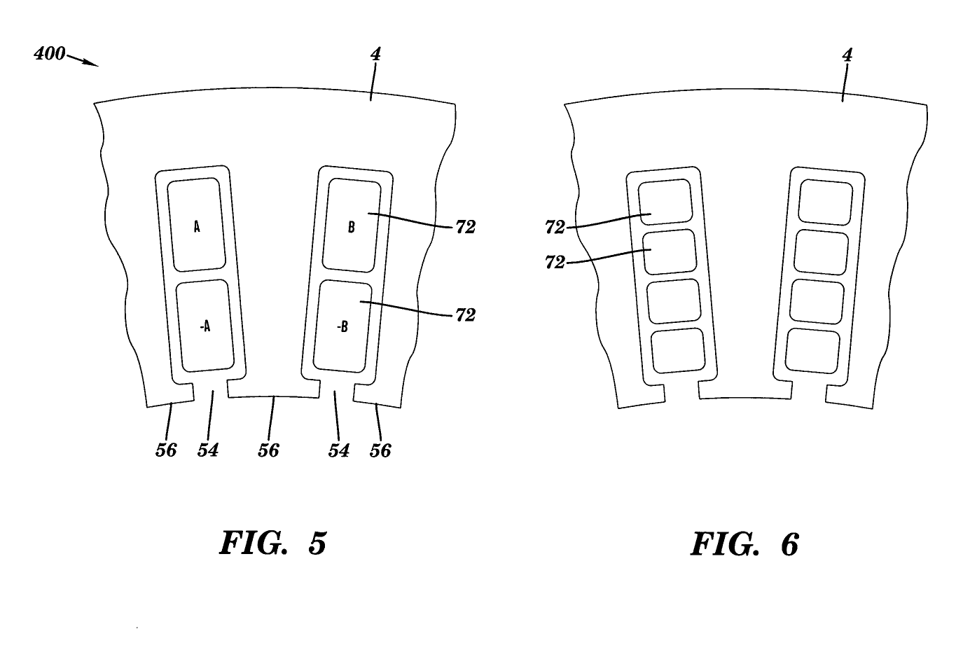

Along with the electrical load escalation, is a continuing trend of higher electrical generation efficiency. Referring to FIG. 4, stator winding 38 of FIG. 1 illustrated as a three phase segmented conductor winding and generally shown at 400 addresses this concern. The stator winding 400 of this invention consists of segmented conductors 72. It is possible to greatly increase the cross sectional area of conductive winding cross sectional area per stator slot 54 with the segmented conductors 72 as best seen with reference to FIGS. 5 and 6. FIG. 5 illustrates the segmented conductor winding 400 with two segmented conductors 72 per stator slot 54 as in FIG. 4, while FIG. 6 illustrates four segmented conductors 72 per stator slot 54. It will be recognized that the number of segmented conductors 72 per slot may be any number of conductors 72 and is not limited to two or four segmented conductors 72 per slot 54.

The segmented conductor winding 400 greatly reduces the ohmic loss of the stator 4 by increasing the slot fill and thereby increases the electrical generating efficiency. Referring again to FIG. 4, each segmented conductor winding 400 extends axially from one face of the stator core 4 in which there are electrical joints 74 between each conductor 72 and a first segment 80 and second segment 82 extending from each conductor 72. Axially extending from the other face or opposite face of the stator core 4 loops are formed in each of the first and second segments 80, 82 generally shown at 76. First and second segments are the joined by at electrical joint 74 into a single conductor 72.

Under normal operation, the winding of the rotor is supplied with a current, which induces a magnetic flux in each of the rotor poles. As the rotor rotates, the flux generated at the poles cuts through the current carrying winding of the stator, generating alternating current in it. The alternating current generated in the stator current-carrying winding passes through rectifying circuitry before it is introduced into the electrical system of the vehicle.

The winding pattern of the stator winding and the configuration of stator teeth and slots are significant factors in the generator's operating characteristics. Generator stators typically have one set of current carrying windings, but can have two or more stator windings. Each winding may consist of multiple coils each corresponding to a respective electrical phase p, of which there are typically three. Wires that make up the stator windings are wound into the slots between adjacent stator teeth. Typically, the wire is wound around the stator teeth several times such that bundles of wire are disposed in each slot. The number of stator teeth around which the wire is wound is referred to as the pitch. The windings are typically wound around three stator teeth, which is called a full pitch pattern, and which encompasses 180 electrical degrees. A short pitch pattern is one where the windings are wound around stator teeth, which encompasses less than 180 electrical degrees. In a full pitch pattern, the wire is guided into a first stator slot, passed over the two slots adjacent to the first stator slot and guided into the fourth stator slot. The coils (e.g., coil A, coil B, and coil C for a three-phase stator winding) are conventionally arranged in either a delta or wye configuration.

Referring again to FIG. 4, it can be seen that in accordance with an exemplary embodiment, coils A, B, and C are illustrated for a three-phase winding and are wound in a full pitch pattern being wound around three teeth 56, although not in the conventional manner discussed above and discussed more fully below. In addition, each phase winding is wound around three teeth 56 defining two slots 54 therebetween, each tooth 54 for receiving a respective phase winding (e.g., coil B and C)

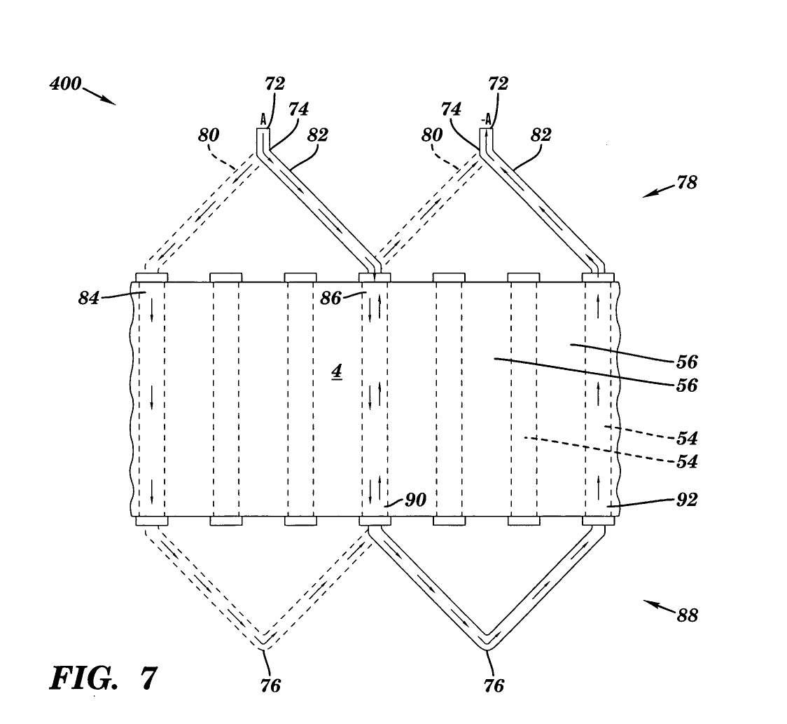

FIG. 7 is a partial plan view illustrating stator 4 with coil A representative of a first phase of the three-phase stator winding 38 depicted in FIG. 4. Coils B and C have been omitted for sake of clarity in describing a winding pattern of the segmented conductors 72 for each phase of multi-phase windings with respect to stator 4 in accordance with an exemplary embodiment. Coils B and C are wound similar to coil A although wound in a pair of respective slots adjacent to those having coil A.

Coil A begins as single conductor 72 that is segmented at a first electrical joint 74 into first and second segments 80, 82 on a first side 78 of stator 4. Segment 80 is shown with phantom lines for sake of clarity and distinction with segment 82. First segment 80 is inserted in a first slot 84 while second segment 82 is inserted in a second slot 86 three slots 54 away from first slot 84 having two slots 54 therebetween. It will be recognized by one skilled in the pertinent art that although first and second slots 84 and 86 are described having two slots 54 therebetween in one exemplary embodiment which is correct for a thirty-six slot electric machine, it is not limited thereto. Mores specifically, electric machines having, for example, but not limited to, 36, 72, 96, etc. slots are also contemplated, such that each of the first and second slots 84 and 86 are spaced 180 electrical degrees from one another in a 36, 72, 96, etc. slot machine. First segment 80 extends from first side 78 through slot 84 to a second side 88 opposite first side 78 defining stator 4, while second segment 82 extends from first side 78 through slot 90 to second side 88. As a result, a given stator slot 54 contains winding elements belonging to only one of the sets of three-phase windings, and magnetic coupling between the sets of three-phase windings due to slot leakage is thereby avoided.

First segment 80 forms a first loop 76 on second side 88 and returns to first side 78 through second slot 90. Second segment 82 forms a second loop 76 on second side 88 and returns to first side through a third slot 92. Third slot 92 is disposed three slots from second slot 90 and six slots 54 from first slot 84 with second slot 90 intermediate first and third slots 84, 92. In this manner, there are two adjacent slots 54 between first and second slots 84, 90 for respective segmented windings of coils B and C to extend from first side 78 to second side 88. Likewise, there are two adjacent slots 54 between second and third slots 90, 92 for the respective windings of segmented coils B and C to extend from second side 88 to first side 78. It will be recognized by one skilled in the pertinent art that first and second segments 80, 82 re-combine after extending to first side 78 from second side 88 to form a single conductor 72 before becoming segmented for insertion with other downstream or upstream slots 54 to complete the respective stator phase winding.

The segmented conductor winding 400 as described above substantially increases a cross sectional area of conductive winding per stator slot, thus reducing the ohmic loss of the stator and thereby increasing the electrical generating efficiency.

By combining the segmented conductor winding 400 in stator 4 in conjunction with the claw pole rotor 100 having three segments 1, 2 into one common electrical machine, the electrical machine produces higher outputs and efficiency at a cost significantly less than alternatives for the same increase in output and efficiency. The alternatives for typical vehicle alternators include, for example, adding magnets between the claw poles of the rotor or using low loss rectifier elements such as FET's or using an actively controlled rectifier bridge with power factor correction. More specifically, an exemplary embodiment of one such machine is an alternating current generator including a field rotor 100 composed or more than two flux carrying segments 1, 2 with each segment having P/2 claw poles where P is an even number; and a stator winding 400 composed of segmented conductors 72 extending through slots 54 as described above. The technical benefits realized by this invention include significant increases in output current and efficiency capability at a cost significantly less than the alternatives for the same increase in output and efficiency.

While the exemplary twin coil claw pole rotor and segmented stator winding have been described for use with generators associated with vehicles, the rotor and segmented stator winding may also be used and incorporated in applications other than generators for a vehicle where enhancement in electrical generation efficiency of a winding is required.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

1. A dynamoelectric machine comprising:
a stator including a stator winding composed of segmented conductors, said stator winding representative of a first phase stator winding of multi-phase stator windings inserted in a plurality of slots defining said stator; and
a rotor rotatable within said stator, a rotor composed of more than two flux carrying segments, each segment having P/2 claw poles, wherein P is an even number.

2. The machine of claim 1, wherein a coil winding is disposed intermediate each of said more than two flux carrying segments.

3. The machine of claim 2, wherein each coil winding is energized providing a first magnetic polarity on outbound claw poles defining said rotor and a second polarity opposite said first polarity on claw poles intermediate said outbound claw poles.

4. The machine of claim 1, wherein permanent magnets are disposed between said each segment to enhance at least one of output and efficiency.

5. The machine of claim 1, wherein said first phase stator winding includes a conductor segmented into a first segment and a second segment, said first segment is inserted in a first slot of said plurality of slots and said second segment inserted in a second slot of said plurality of slots, said first and second slots having being spaced 180 electrical degrees apart.

6. The machine of claim 5, wherein said first and second segments extend from a first side of said stator to a second side defining said stator, said first segment returns to said first side through said second slot, said second segment returns to said first side through a third slot.

7. The machine of claim 6, wherein said first and second segments form respective loops on said second side before returning to said first side.

8. The machine of claim 6, wherein said third slot is three slots from said second slot and six slots from said first slot with said second slot therebetween.

9. The machine of claim 6, wherein said first and second segments combine after extending to said first side from said second side to form a single conductor.

10. The machine of claim 1, wherein said multi-phase stator windings include three-phase stator windings having said first phase stator winding, a second and a third phase stator winding.

11. The machine of claim 10, wherein each of said plurality of slots is occupied by a respective segmented conductor of one of said first, second, and third phase stator windings.

12. The machine of claim 11, wherein each slot is filled with a plurality of segments from a single phase conductor.

13. An alternating current (AC) generator for a motor vehicle comprising:
a stator including a stator winding composed of segmented conductors, said stator winding representative of a first phase stator winding of multi-phase stator windings inserted in a plurality of slots defining said stator; and
a field rotor rotatable within said stator, said rotor including more than two flux carrying segments, each segment having P/2 claw poles, wherein P is an even number.

14. The generator of claim 13, wherein a coil winding is disposed intermediate each of said more than two flux carrying segments.

15. The generator of claim 14, wherein each coil winding is energized providing a first magnetic polarity on outbound claw poles defining said rotor and a second polarity opposite said first polarity on claw poles intermediate said outbound claw poles.

16. The generator of claim 13, wherein permanent magnets are disposed between said each segment to enhance at least one of output and efficiency.

17. The generator of claim 13, wherein said first phase stator winding includes a conductor segmented into a first segment and a second segment, said first segment is inserted in a first slot of said plurality of slots and said second segment inserted in a second slot of said plurality of slots, said first and second slots being spaced 180 electrical degrees apart.

18. The generator of claim 17, wherein said first and second segments extend from a first side of said stator to a second side defining said stator, said first segment returns to said first side through said second slot, said second segment returns to said first side through a third slot.

19. The generator of claim 18, wherein said first and second segments form respective loops on said second side before returning to said first side.

20. The generator of claim 18, wherein said third slot is three slots from said second slot and six slots from said first slot with said second slot therebetween.

21. The generator of claim 18, wherein said first and second segments combine after extending to said first side from said second side to form a single conductor.

22. The generator of claim 13, wherein said multi-phase stator windings include three-phase stator windings having said first phase stator winding, a second and a third phase stator winding.

23. The generator of claim 22, wherein each of said plurality of slots is occupied by a respective segmented conductor of one of said first, second, and third phase stator windings.

24. The machine of claim 23, wherein each slot is filled with a plurality of segments from a single phase conductor.
